(19) United States
(12) Patent Application Publication
(10) Pub. No.: US 2026/0074795 A1
(43) Pub. Date: Mar. 12, 2026

(54) COHERENT OPTICAL TRANSMISSION SYSTEM WITH MULTI-USE LASER EMITTER AND OPTICAL TRANSCEIVER THEREOF

(71) Applicant: Global Technology Inc., Ningbo (CN)

(72) Inventors: Weikang KE, Ningbo (CN); Fan YANG, Ningbo (CN); Luyang QI, Ningbo (CN)

(21) Appl. No.: 18/976,589

(22) Filed: Dec. 11, 2024

(30) Foreign Application Priority Data
Sep. 12, 2024 (CN) 202411277044.9

(51) Int. Cl. H04B 10/40; H04B 10/50; H04B 10/61

(52) U.S. Cl. CPC H04B 10/40; H04B 10/5057; H04B 10/614; H04B 10/6163

(57) ABSTRACT

A coherent optical transmission system includes two optical transceivers, each including a laser emitter, an optical splitting module, an optical modulator, an optical mixer and an optical detector. The laser emitter is configured to emit an initial light. The optical splitting module is configured to divide the light emitted by the laser emitter into a reference light and a signal light. The optical modulator is configured to modulate the signal light. The optical mixer is optically coupled to the optical splitting module. The optical mixer of the first optical transceiver is configured to optically mixing the reference light of the first optical transceiver and the signal light of the second optical transceiver, and the optical mixer of the second optical transceiver is configured to optically mixing the reference light of the second optical transceiver and the signal light of the first optical transceiver.

### CROSS-REFERENCE TO RELATED APPLICATIONS

This non-provisional application claims priority under 35 U.S.C. § 119(a) on Patent Application No(s). 202411277044.9 filed in China on Sep. 12, 2024, the entire contents of which are hereby incorporated by reference.

### BACKGROUND

### 1. Technical Field This disclosure relates to an optical transceiver and a coherent optical transmission system.

### 2. Related Art

The optical module may transmit and/or receive optical signals for applications such as but not limited to the network data center, the cable TV and the fiber to the home (FTTH). Using optical modules for transmission may provide higher transmission rates and signal bandwidth over longer transmission distances. In order to promote the compatibility of global optical Internet products and reduce the maintenance burden, organizations such as the Multi-Source Agreement (MSA), the Institute of Electrical and Electronics Engineers (IEEE), and the Optical Internetworking Forum (OIF) have developed several form factors (Form Factor) suitable for different signal transmission rates. These form factors include but are not limited to XFP, SFP, QSFP (Quad Small Form Factor Pluggable), QSFP-DD (Double Density), OSFP (Octal Small Form Factor Pluggable) and CPO (Co-Packaged Optics).

Existing optical modules faces challenges in optical power, space management, thermal management, insertion loss and manufacturing yield.

### SUMMARY

According to one embodiment of this disclosure, a coherent optical transmission system includes a first optical transceiver and a second optical transceiver. The two optical transceivers each includes a laser emitter, an optical splitting module, an optical modulator, an optical mixer and an optical detector. The laser emitter is configured to emit an initial light. The optical splitting module is optically coupled to the laser emitter and is configured to divide the light emitted by the laser emitter into a reference light and a signal light. The optical modulator is optically coupled to the optical splitting module and is configured to modulate the signal light. The optical mixer is optically coupled to the optical splitting module. The optical detector is optically coupled to the optical mixer. The optical mixer of the first optical transceiver is configured to mix the reference light of the first optical transceiver and the signal light of the second optical transceiver, and the optical mixer of the second optical transceiver is configured to mix the reference light of the second optical transceiver and the signal light of the first optical transceiver.

According to one embodiment of this disclosure, an optical transceiver that is applicable for a coherence optical transmission system includes a laser emitter, an optical splitting module, an optical modulator, an optical mixer and an optical detector. The laser emitter is configured to emit an initial light. The optical splitting module is optically coupled to the laser emitter and is configured to divide the initial light into a first reference light and a first signal light. The optical modulator is optically coupled to the optical splitting module and is configured to modulate the first signal light. The optical mixer is optically coupled to the optical splitting module and is configured to mix the first reference light and second signal light. The optical detector is optically coupled to the optical mixer.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a block diagram of an optical transceiver according to an embodiment of the present disclosure; and

FIG. 2 is a block diagram of a coherent optical transmission system according to an embodiment of the present disclosure.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present invention. The following embodiments further illustrate various aspects of the present invention, but are not meant to limit the scope of the present invention.

With the rapid development of emerging technologies such as artificial intelligence, big data, and the Internet of Things (IOT), signal transmission capacity continues to increase, optical communication technology is also developing rapidly, and the demand and requirements for optical modules also becomes higher. Currently, the increase of transmission distance is a critical issue for optical modules.

Among the optical modules for long-distance transmission applications, coherent optical transmission systems are used as a solution for long-distance transmission applications due to their advantages of low power consumption and high transmission rate. For example, the optical modules with transmission rates above 25 Gbps and transmission distances greater than 40 kilometers are used in application. However, the equipment of coherent optical transmission systems is complex and costly, which limits its popularity in practical applications. A known coherent optical transmission system requires a laser specifically used as a local oscillator light source, which makes it difficult to reduce the manufacturing and maintenance costs of the system.

According to the optical transceiver and the coherent optical transmission system disclosed in the embodiment of the present disclosure, the initial light of the laser emitter is divided into a reference light and a signal light through the optical splitting module, and there is a frequency difference between the signal light and the reference light. After the signal light is modulated by the optical modulator, the reference light and the signal light having a frequency difference from each other can be mixed. In this way, the laser emitter of an optical transceiver may not only serve as the optical transmitter (Tx) of the optical transceiver to provide the signal light to the optical modulator, but may also serve as a local oscillator light source to provide the reference light to the optical receiving end (Rx) of this optical transceiver. Accordingly, without the need to set up an additional local oscillator light source, the received electrical signal generated by the optical detector receiving the mixed light may be analyzed based on the coherence conditions generated between the reference light and the signal light, thereby achieving high-speed, high-sensitivity detection, improving the stability and distance of signal transmission, and reducing costs at the same time.

Those with ordinary knowledge in the art may reasonably combine and configure the technical features disclosed herein to achieve corresponding technical effects.

The term “coupling” or “coupling” refers to any connection, link, or similar relationship, and “optical coupling” or “optical coupled” refers to the relationship in which light is transmitted (impart) from one element to another element. Unless otherwise stated, elements that are coupled or coupling to each other do not have to be directly connected to each other and may be separated by intervening elements.

The term “substantially” refers to a degree of accuracy within an acceptable margin of error, wherein the acceptable margin of error is considered and reflects the small real-world variation caused by material composition, material defects and/or limitations/peculiarities in the manufacturing process. Such changes may thus be described as achieving the stated properties to a large extent, but do not have to completely achieve the stated properties.

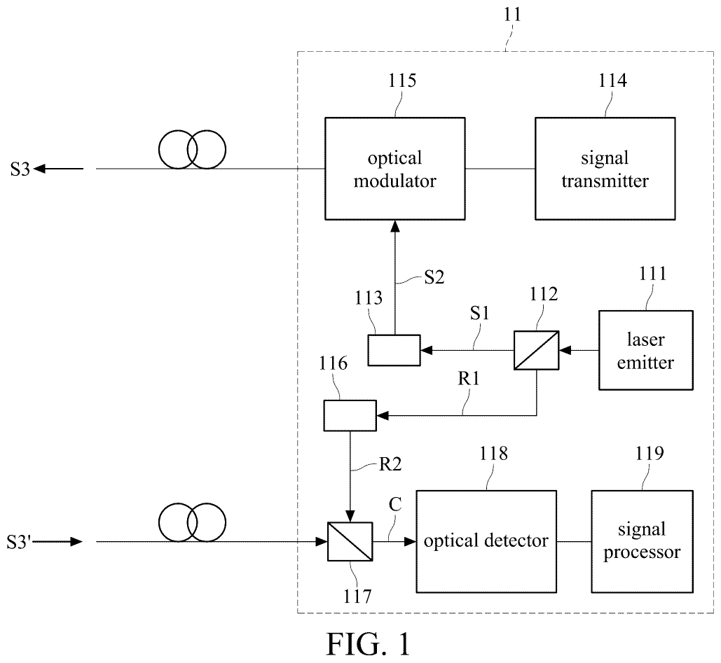

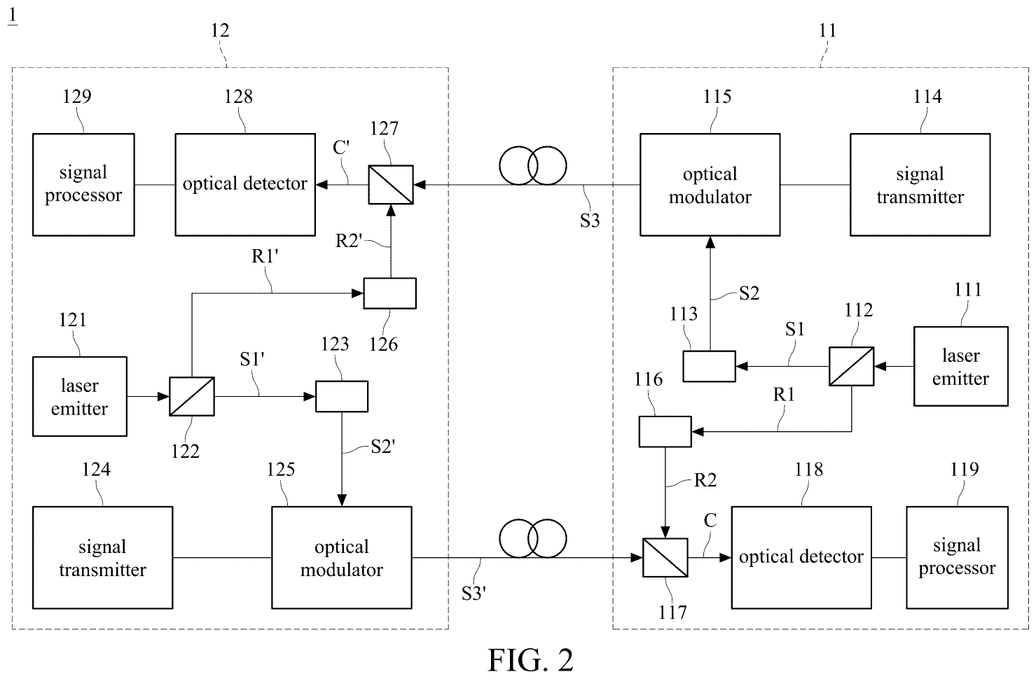

Please refer to FIG. 1 and FIG. 2, FIG. 1 is a block diagram of an optical transceiver according to an embodiment of the present disclosure, FIG. 2 is a block diagram of a coherent optical transmission system according to an embodiment of the present disclosure.

According to one embodiment, the optical transceiver 11 may include a laser emitter 111, an optical splitter 112, an optical modulator 115, a wavelength selector 116, an optical mixer 117, an optical detector 118 and a signal processor 119. The laser emitter 111 may be configured to emit an initial light. The optical splitter 112 may be configured to receive the initial light and divide the initial light into a first reference light R1 and a first signal light S1. According to one embodiment, the optical modulator 115 may be a Mach-Zehnder modulator in a form of, for example, a silicon photonic chip or a thin film lithium niobate (TFLN) chip. The optical modulator 115 may be configured to receive the first signal light and modulate the first signal light according to an input signal. The wavelength selector 116 may be configured to receive the first reference light R1 and adjust the center wavelength of the first reference light R1. The optical mixer 117 may be configured to receive the first reference light R2 with an adjusted center wavelength and second signal light S3′, and generate coupled light C. The optical detector 118 may be configured to receive the coupled light C to generate a received electrical signal. According to one embodiment, the optical detector 118 includes a photodiode. The signal processor 119 may be connected to the optical detector 118, and may be configured to analyze the received electrical signal to obtain information related to the second signal light S3′. According to one embodiment, the signal processor 119 includes a digital signal processor (DSP).

According to one embodiment, the coherent optical transmission system 1 may include at least two optical transceivers 11 and 12, wherein each optical transceiver 11 may include a laser emitter 111, an optical splitter 112, an optical modulator 115, a wavelength selector 116, an optical mixer 117, an optical detector 118 and a signal processor 119. The laser emitter 111 is configured to emit an initial light. The optical splitter 112 is configured to receive the initial light and divide the initial light into a reference light R1 and a signal light S1. The optical modulator 115 is configured to receive the signal light and modulate the signal light according to an input signal. The wavelength selector 116 is configured to receive the reference light R1 and adjust the center wavelength of the reference light R1. In one embodiment, the wavelength selector 116 may select a center wavelength of the reference light R1 (and filter out other frequency components), wherein the center wavelength may belong to the original frequency spectrum of the reference light R1. In one embodiment, the wavelength selector 116 may change/shift the center wavelength of the reference light R1, and this can be achieved by means of, for example, nonlinear optics such as nonlinear phase-change material. The optical mixer 117 is configured to receive the reference light R2 with an adjusted center wavelength and the signal light S3′ from the optical modulator 125 of another optical transceiver 12, and generate coupled light C. The optical detector 118 is configured to receive the coupled light C to generate a received electrical signal. The signal processor 119 is connected to the optical detector 118 and is configured to analyze the received electrical signal to obtain information related to the signal light S3′ from another optical transceiver 12. For example, the signal processor 119 may be any circuit or module applicable for processing optical signals, such as a demodulator or amplifier. Through the processing of the signal processor 119, the original input signal may be retrieved to realize the long-distance transmission function.

According to one embodiment, the coherent optical transmission system 1 may include multiple optical transceivers (not limited to two optical transceivers 11 and 12), and the configuration of each optical transceiver may be basically the same and can be modified according to actual application requirements. For the same or similar configurations of individual optical transceivers, the present disclosure may merely illustrate and describe one optical transceiver as an example, and omit repeated description. According to one embodiment, each optical transceiver may have an optical receiving terminal and an optical transmitting terminal. The optical transceiver may include and integrate an optical transmitting assembly (TOSA) and an optical receiving assembly (ROSA). The following description does not specify whether an individual component belongs to the optical transmitting assembly (TOSA) or the optical receiving assembly (ROSA).

According to an embodiment, the optical transceiver 11 may simply include one laser emitter 111 without other laser emitter. According to one embodiment, the optical transceiver 11 does not need an additional local oscillator light source, instead, the optical transceiver 11 may split the light from the laser emitter 111 through the optical splitter 112 and use the reference light as the local oscillator light. The laser emitter 111 may be configured to emit an initial light having a wavelength range. The wavelength range of the initial light emitted by the laser emitter 111 may belong to the infrared light. For example, the infrared light may cover a wavelength range of 1500 nm to 1600 nm. According to one embodiment, the laser emitter 111 may be a wavelength-tunable laser. According to one embodiment, the laser emitter 111 may be a Fabry-Perot (FP) laser.

According to one embodiment, the optical splitter 112 may be a beam splitter or an optical fiber splitter, which is configured to split the initial light into the signal light S1 and the reference light R1 through the partial transmission/reflection characteristics of the interface. Here, the signal light S1 or the reference light R1 is not limited to be the reflected light or the transmitted light. FIG. 1 and FIG. 2 merely serve as examples. The power ratio between the signal light S1 and the reference light R1 may be determined according to actual requirement. For example, considering that the signal light S1 would pass through multiple components along optical path and undergo long-distance transmission, the optical splitter 112 may selectively allocate more power (of the initial light) to the signal light S1. According to one embodiment, as shown in FIG. 1 and FIG. 2, the optical splitter 112, the wavelength selector 113 and the wavelength selector 116 may be regarded as the optical splitting module of the optical transceiver 11, and the optical splitter 122, the wavelength selector 123 and the wavelength selector 126 may be regarded as the optical splitting module of the optical transceiver 12. According to one embodiment, the optical splitter 112, the wavelength selector 113 and the wavelength selector 116 may be replaced by a photo-demultiplexer, such as the arrayed waveguide gratings (AWG) or the Z-block type photo-demultiplexer. The photo-demultiplexer may also divide the initial light into signal light S1 and reference light R1.

According to one embodiment, for the reference light R1, the wavelength selector 116 may be configured to adjust the center wavelength of the reference light R1, so that there may be a specific frequency difference between the reference light R2 with the adjusted center wavelength and the signal light S3′ from another optical transceiver. In one embodiment, there may be a frequency difference of 25 GHz to 30 GHz between the reference light R2 with the adjusted center wavelength and the signal light S3′. Then, the optical mixer 117 may couple the reference light R2 with the adjusted center wavelength and the signal light S3′ to generate the coupled light C. In this way, the reference light R2 with the adjusted center wavelength may produce a heterodyne coherent modulation effect on the signal light S3′. In this embodiment, the optical mixer 117 and the optical splitter 112 may be the same or similar components, and the repeated description is omitted here. According to one embodiment, the coupled light C may be corresponding to an intermediate frequency signal obtained by mixing the reference light R2 and the signal light S3′.

According to one embodiment, the optical detector 118 may receive the coupled light C and generate a received electrical signal. For example, the optical detector 118 may be a photodiode or other device that can convert optical signals into electrical signals, which is not limited in this disclosure. The coupled light C may be analyzed with a balanced optical receiver to produce an electrical signal associated with the signal light S3′ from another optical transceiver. According to one embodiment, heterodyne detection may be used to analyze the received electrical signal to obtain information related to the signal light S3′ from another optical transceiver. Thereby, the received electrical signal generated by the optical detector 118 receiving the coupled light C may be analyzed based on the coherence conditions generated between the reference light R2 and the signal light S3′, to achieve high-speed, high-sensitivity detection, and improve the stability and distance of signal transmission.

According to one embodiment, for the signal light S1 generated by the optical splitter 112, the optical modulator 115 may obtain an input signal and modulate the signal light with the information of the input signal to generate the signal light S3, and transmit the signal light S3 to other optical transceivers through optical fiber. In one embodiment, the input signal may be generated by a signal transmitter 114, and the signal transmitter 114 may be included in the optical transceiver 11. In one embodiment, the input signal may originate from a signal source external to the optical transceiver 11, which is not limited in this disclosure. According to one embodiment, the optical transceiver 11 may further include another wavelength selector 113 for receiving the signal light S1 and selecting center wavelength of the signal light, to generate the signal light S2. Furthermore, the optical modulator 115 can be used to receive the signal light S2 having a single main peak wavelength and modulate the signal light S2 according to the input signal to generate the signal light S3 with selected center wavelength.

For example, the two wavelength selectors 113 and/or 116 may be the distributed Bragg reflector (DBR). The distributed Bragg reflector has a multi-layer stack structure that can be used to produce constructive interference and high reflectivity for specific wavelengths of light (in relative to the above, the distributed Bragg reflector can produce destructive interference and low reflectivity for other wavelengths), thus having wavelength selective properties. According to one embodiment, the signal light S1 and the reference light R1 generated by the optical splitter 112 may have multiple main peak wavelengths within a frequency range. The two wavelength selectors 113 and 116 may target different specific wavelengths. In one embodiment, when the signal light S1 is reflected by the distributed Bragg reflector (wavelength selector 113), the generated signal light S2 may have a single main peak wavelength (corresponding to the first wavelength). When the reference light R1 is reflected by the distributed Bragg reflector (wavelength selector 116), the center wavelength of the generated reference light S2 may be shifted to the second wavelength. There may be a frequency difference between the first wavelength and the second wavelength, and the frequency difference may be, for example, 25 GHz to 30 GHz, thereby generating coherent conditions and achieving a heterodyne coherent modulation effect.

As shown in FIG. 2, the coherent optical transmission system 1 of this embodiment may include two optical transceivers 11 and 12. The configuration of the optical transceiver 12 is basically the same as that of the optical transceiver 11, so repeated descriptions are omitted. In connection relationship, the optical modulator 115 of the optical transceiver 11 may be connected to the optical mixer 127 of another optical transceiver 12 through an optical fiber, and the optical modulator 125 of the optical transceiver 12 may be connected to the optical mixer 117 of another optical transceiver 11 through an optical fiber, thereby achieving bidirectional optical transmission. According to an embodiment, the coupled light C′ may correspond to an intermediate frequency signal obtained by mixing the reference light R2′ and the signal light S3.

In the following, the transmitting end of the optical modulator 115 that outputs the signal light S3 is used as the optical transmitting end of the optical transceiver 11, and the receiving end of the optical mixer 117 that receives the signal light S3′ is used as the optical receiving end of the optical transceiver 11. In other embodiments, the optical transmission system may include multiple optical transceivers. For example, the optical transmitting end of the first optical transceiver may be coupled to the optical receiving end of the second optical transceiver through an optical fiber, the optical transmitting end of the second optical transceiver may be coupled to the optical receiving end of the third optical transceiver through an optical fiber, . . . and so on. That is, in this disclosure, the arrangement relationship between the plurality of optical transceivers is not restricted in a specific way.

In view of above, according to the optical transceiver and the coherent optical transmission system disclosed in the embodiment of the present disclosure, the initial light of the laser emitter is divided into a reference light and a signal light through the optical splitting module, and there is a frequency difference between the signal light and the reference light. After using the optical modulator to modulate the signal light, the reference light and the signal light having a frequency difference from each other can be mixed. In this way, the laser emitter of an optical transceiver may not only serve as the optical transmitter (Tx) of the optical transceiver to provide signal light to the optical modulator, but may also serve as a local oscillator light source to provide reference light to the optical receiving end (Rx) of this optical transceiver. Accordingly, without the need to set up an additional local oscillator light source, the received electrical signal generated by the optical detector receiving the mixed light may be analyzed based on the coherence conditions generated between the reference light and the signal light, thereby achieving high-speed, high-sensitivity detection, improving the stability and distance of signal transmission, and reducing costs at the same time.

What is claimed is:

1. A coherent optical transmission system, comprising:
a first optical transceiver and a second optical transceiver, each comprising:
a laser emitter configured to emit an initial light;
an optical splitting module optically coupled to the laser emitter, and the optical splitting module configured to divide the initial light into a reference light and a signal light;
an optical modulator optically coupled to the optical splitting module, and the optical modulator configured to modulate the signal light;
an optical mixer optically coupled to the optical splitting module; and
an optical detector optically coupled to the optical mixer,
wherein the optical mixer of the first optical transceiver is configured to mix the reference light of the first optical transceiver and the signal light of the second optical transceiver, and the optical mixer of the second optical transceiver is configured to mix the reference light of the second optical transceiver and the signal light of the first optical transceiver.

2. The coherent optical transmission system of claim 1, wherein the optical splitting module comprises:
an optical splitter optically coupled to the laser emitter, and the optical splitter configured to divide the initial light into the reference light and the signal light;
a first wavelength selector optically coupled to the optical splitter and the optical mixer, and the first wavelength selector configured to adjust center wavelength of the reference light; and
a second wavelength selector optically coupled to the optical splitter, and the second wavelength selector configured to select center wavelength of the signal light,
wherein the optical modulator is optically coupled to the second wavelength selector and is configured to modulate the signal light with selected center wavelength.

3. The coherent optical transmission system of claim 2, wherein the first wavelength selector and/or the second wavelength selector is a distributed Bragg reflector.

4. The coherent optical transmission system of claim 2, wherein there is a frequency difference of 25 GHz to 30 GHz between the reference light with adjusted center wavelength and the signal light.

5. The coherent optical transmission system of claim 1, wherein information of the signal light is analyzed through heterodyne detection.

6. The coherent optical transmission system of claim 1, wherein the initial light emitted by the laser emitter is within an infrared light wavelength range.

7. The coherent optical transmission system of claim 1, wherein each of the first optical transceiver and the second optical transceiver comprises the laser emitter without other laser emitter.

8. The coherent optical transmission system of claim 1, wherein the optical mixer of the first optical transceiver only receives the reference light of the first optical transceiver and the signal light of the second optical transceiver, and the optical mixer of the second optical transceiver only receives the reference light of the second optical transceiver and the signal light of the first optical transceiver.

9. The coherent optical transmission system of claim 1, wherein the laser emitter is an FP laser.

10. An optical transceiver of a coherence optical transmission system, the optical transceiver comprising:
a laser emitter configured to emit an initial light;
an optical splitting module optically coupled to the laser emitter, and the optical splitting module configured to divide the initial light into a first reference light and a first signal light;
an optical modulator optically coupled to the optical splitting module, and the optical modulator configured to modulate the first signal light;
an optical mixer optically coupled to the optical splitting module, and the optical mixer configured to mix the first reference light and a second signal light, wherein the second signal light comes from another laser emitter different from the laser emitter; and
an optical detector optically coupled to the optical mixer.

11. The optical transceiver of the coherence optical transmission system of claim 10, wherein the optical splitting module comprises:
an optical splitter optically coupled to the laser emitter, and the optical splitter configured to divide the initial light into the first reference light and the first signal light;
a first wavelength selector optically coupled to the optical splitter and the optical mixer, and the first wavelength selector configured to adjust center wavelength of the first reference light; and
a second wavelength selector optically coupled to the optical splitter, and the second wavelength selector configured to select center wavelength of the first signal light,
wherein the optical modulator is optically coupled to the second wavelength selector and is configured to modulate the first signal light with selected center wavelength.

12. The optical transceiver of the coherence optical transmission system of claim 11, wherein the first wavelength selector and/or the second wavelength selector is a distributed Bragg reflector.

13. The optical transceiver of the coherence optical transmission system of claim 11, wherein there is a frequency difference of 25 GHz to 30 GHz between the first reference light with adjusted center wavelength and the second signal light.

14. The optical transceiver of the coherence optical transmission system of claim 10, wherein information of the second signal light is analyzed through heterodyne detection.

15. The optical transceiver of the coherence optical transmission system of claim 10, wherein the initial light emitted by the laser emitter is within an infrared light wavelength range.

16. The optical transceiver of the coherence optical transmission system of claim 10, wherein the optical transceiver comprises the laser emitter without other laser emitter.

17. The optical transceiver of the coherence optical transmission system of claim 10, wherein the optical mixer only receives the first reference light and the second signal light.

18. The optical transceiver of the coherence optical transmission system of claim 10, wherein the laser emitter is an FP laser.
